(19) United States
(12) Patent Application Publication
(10) Pub. No.: US 2014/0267019 A1
(43) Pub. Date: Sep. 18, 2014

(54) CONTINUOUS DIRECTIONAL INPUT METHOD WITH RELATED SYSTEM AND APPARATUS

(71) Applicant: MICROTH, INC., Staten Island, NY (US)

(72) Inventor: Yevgeniy KUZMIN, Celebration, FL (US)

(73) Assignee: MICROTH, INC., Staten Island, NY (US)

(21) Appl. No.: 14/206,084

(22) Filed: Mar. 12, 2014

Related U.S. Application Data
(60) Provisional application No. 61/789,330, filed on Mar. 15, 2013.

(51) Int. Cl. G06F 3/03; G06F 3/01

(52) U.S. Cl. CPC G06F 3/03; G06F 3/017
USPC 345/156

(57) ABSTRACT

A method for continuous directional input may include using a processor and memory to track parameters of a continuous spatial trace of a parametric process, and detect positions along the continuous spatial trace that correspond to selectable directional input events and subdivide the continuous spatial trace into trace segments. The processor and memory may calculate directional characteristics in positions of the selectable directional input events at ends of each trace segment, determine input indexes corresponding to the directional characteristics of each trace segment, and convert a sequence of indexes into assigned input values.

### RELATED APPLICATIONS

This application is based upon prior filed co-pending application Ser. No. 61/789,330 filed Mar. 15, 2013, the entire subject matter of which is incorporated herein by reference in its entirety.

### TECHNICAL FIELD

The present disclosure relates generally to methods and systems for input and control for electronic devices and, more particularly, to input and control interfaces based on processing of directional characteristics of continuous spatial traces in positions of input events.

### BACKGROUND

With the development of computers and electronic devices, data input and control have become one of the fundamental problems of computer-human interaction. Typical data input systems are usually based on language writing systems with elementary input actions corresponding to symbols of language script system. The most common implementation of such script-based input system is the keyboard with input keys representing symbols of scripts. A keyboard may become a cumbersome and inconvenient approach for languages using scripts with a number of symbols greater than the number of keys of regular keyboards.

Miniaturization of electronic devices in general, development of mobile devices especially, and adding of communication functions to wearable devices with limited input interfaces may cause issues with input and control of such devices. Limited screen and surface area of mobile and wearable devices may not provide enough space for a convenient hardware or virtual keyboard, but miniature keyboards may be difficult to use.

Among possible approaches to this problem, handwriting and gesture recognition is a typical approach because it is intuitive, fast, and requires a small footprint on a device. However, in general, handwriting and gesture recognition may be typically restrictive, i.e. perhaps requiring memorization of some rules, depending on user writing habits, sophisticated processing and hardware as well as being less accurate and less flexible than keyboard input.

Different approaches have been proposed to address the aforementioned problems. Many approaches, such as Unistroke™ from the Xerox Corporation and Graffiti™ from Palm, Inc., may require inputting only special, simplified strokes. In these approaches, symbols are typically represented by only one stroke. Using only one stroke per letter simplifies the processing algorithms, but even small deviation from standard shape during the input may lead to recognition errors. Another issue is that gestures are not continuous, and require a lifting of stylus at the end of each symbol. That may considerably slow down the speed of input.

The common drawback of some shape recognition algorithms is that differently to keyboard typing, where user should control finger motions only at short moments of keys strokes, the shape recognition requires global user control of all gesture positions during the input. Any position deviation along the trace from a target gesture at any moment may lead to misrecognition. Such permanent shape control may be very difficult and reduce usability of input method based on shape recognition. Therefore, it may be desirable that a gesture input method is local and may require user control only in positions corresponding some input events and is shape-independent in all other positions. This is similar to mouse gestures, when input events happened only by mouse clicks, but the rest of the gesture doesn't have a direct impact on the input.

To reduce shape-dependency and number of input events, some approaches are based on recognition of gesture shapes over low-resolution rectangular matrixes, plane subdivisions or a set of planar regions. Such positional gesture input methods are based on the recognition of sequences of regions or other geometric features, interacted with an input object during the input of a gesture. Usually, they have quite simple recognition algorithms due to additional restrictions on input events, but often they are also time-dependent upon the input by the user.

U.S. Pat. No. 7,519,748 to Kuzmin, the contents of which are hereby incorporated by reference in their entirety, discloses a time-independent method of positional stroke input, represented by a sequence of selection regions of arbitrary shapes during the swipe. This approach may have less shape limitation and may be applied to wide range of input application. A potential drawback is that, like any positional stroke approach, it may use accurate order of tracing of a gesture throw screen regions. Also, this method may not be well suited for recognition of continuous gestures.

There are several approaches based on the recognition of continuous positional gestures. Quickwriting of K. Perlin recognizes letters by tracking sequences of activated regions around the central resting zone. A gesture for each letter starts and ends in the central zone, and input events happen when the input object is moving into the central zone, providing continuous gestures at the word level. The similar approach, Cirrin of Jennifer Mankoff and Gregory D. Abowd tracks letters regions activated during a swipe. Letter regions are placed at circular keyboard with large empty central zone providing an unambiguous letter selection during a continuous swipe. Continuous positional gestures over a convenient on-screen matrix keyboards, represented by a sequence of keys activated during a swipe connecting desired letters, are disclosed in U.S. Pat. No. 7,098,896 to Kushler et al. and Shumin Zhao and Per-Ola Kristensson in Shorthand Writing on Stylus Keyboard. These approaches are very ambiguous, because many regions along a swipe are unnecessarily activated, and therefore may require a sophisticated disambiguating algorithm. U.S. Pat. No. 8,237,681 to Stephanick et al. discloses an approach partially resolving this issue, by considering only regions in which swipe has some predetermined motion patterns.

The potential drawback of approaches based on positional gestures is that they may require a visual guidance over some background region structure for positioning of the input object in these regions. Positional gestures cannot be entered blindly, in the absence of region background. Moreover, for 3D and higher dimension gestures, a visualization of input regions background may be difficult or even impossible. Therefore, position-independent gesture input methods, which don't depend on positions of input events, may be highly desirable.

One of the possible approaches of this issue is usage of directional information of a gesture. This approach is position independent and allows drawing of gestures at any place at the screen. U.S. Pat. No. 7,535,460 to Momose discloses an approach utilizing length and direction of straight-line segments for shape recognition. This approach may be limited to polygons and heavily uses length information for recognition, which may be difficult to control during a blind input. U.S. Pat. No. 5,598,187 to Ide et al discloses a similar approach based on recognition of shapes of directional patterns of 3D gestures.

A similar approach is disclosed in U.S. Patent Application Publication No. 2012/0254197 to Kuzmin, the contents of which are hereby incorporated by reference in their entirety, which discloses continuous directional gestures based on sequences of directional displacements. The drawback of this approach may be that it is limited to straight line segments, and the user has a limited control over the shape of the gesture for arbitrary inputs, and in some cases, the input gesture may have a size greater then input area. As for coordinate gestures, another potential drawback of these directional approaches may be that for correct input recognition, a user should control direction vectors in all positions of a path, and deviations from exemplary directions or shapes may lead to misrecognition of input.

The interposition of an input object in the space may be described not only by its coordinates, but also by its orientation. The sequence of orientation parameters may be considered as a gesture in the space of orientation parameters. U.S. Pat. No. 7,778,818 to Longe et al. discloses a method, which uses a joystick for ambiguous selection of regions around the central position. This approach is similar to coordinate positional gestures in the orientation space. Many other parameters of object may be considered as positions in corresponding parametric spaces and determine states of input object. For example, a sensor may provide velocity information about the input object, and a recognition method may work in this parametric space.

### SUMMARY

Accordingly, improved methods and user interfaces are desired to provide simple and efficient time, position and shape-independent input and control systems for a broad range of electronic devices, applications and languages.

In view of the foregoing background, it is therefore an object of the present disclosure to provide a method for continuous directional input. The method may include using a processor and memory to track a plurality of parameters of a continuous spatial trace of a parametric process, detect a plurality of positions along the continuous spatial trace that correspond to a plurality of selectable directional input events and subdivide the continuous spatial trace into a plurality of trace segments, calculate directional characteristics in positions of the plurality of selectable directional input events at ends of each trace segment, determine input indexes corresponding to the directional characteristics of each trace segment, and convert a sequence of indexes into a plurality of assigned input values.

In some embodiments, the parametric process may comprise a motion of an input object, and the continuous spatial trace may be defined by a temporal sequence of any subset of a plurality of values of positions, directions and orientations of the input object during the motion. In other embodiments, the continuous spatial trace may comprise a path of touch position of the input object in a coordinate space of a touch sensor. In yet other embodiments, the continuous spatial trace may comprise a path of an image of the input object in projection to an image space of a video camera.

Also, the continuous spatial trace may comprise a path of the input object reconstructed by a processing a video from a camera embedded in the input object. The continuous spatial trace may comprise a path having a shape based upon a handwritten symbol. The input object may comprise at least one of: a sensor, a camera, a stylus, a pen, a wand, a laser pointer, a cursor, a ring, a bracelet, a glass, an accessory, a tool, a phone, a watch, an input device, a toy, an article of clothing, a finger, a hand, a thumb, an eye, an iris, a part of human body, a joystick, and a computer mouse.

More specifically, the positions of the plurality of selectable directional input events along the continuous spatial trace may comprise at least one of: initial and final positions, positions of direction changes, positions of direction discontinuous, positions of direction extremes, positions of extreme values of curvature, positions of stops, positions of inflexion, positions of orientation changes, and positions of orientation extremes. The positions of the plurality of selectable directional input events may comprise positions of user-triggered events.

The directional characteristics for each trace segment may comprise at least one of the following directions of tangential vectors to a trace and orientation vectors of an input object at positions of input events at ends of the trace segment and signed spins between these vectors along the trace segment. The determination of the input indexes corresponding to the directional characteristics may be based on a determination of which index regions from a plurality of index regions in a space of directional characteristics include the given directional characteristics.

In some embodiments, each index region from the plurality of index regions may have an equal size. In other embodiments, each index region from the plurality of index regions may have a size proportional to a respective frequency of an assigned input value. At least two index regions from the plurality of index regions may be overlapping. The input values may comprise at least one of: nodes of a tree, letters of an alphabet, symbols, numbers, syllables, ideographic characters, script elements, words, passwords, stems, strings, macros, control actions, tasks, operations, states, functions, applications, decisions, outcomes and any other values from a list of indexed values.

Additionally, the conversion of the sequence of indexes of index regions may further comprise editing of input values assigned to input indexes, assignment of new input values, and deletion of assigned input values. The conversion of a sequence of indexes of index regions may further comprise a disambiguation of indexes and selection of desired input values from a set of input values associated with overlapped index regions.

The conversion of the sequence of indexes of index regions may comprise comparing the sequence of input indexes to pre-defined password sequences of indexes to perform at least one of actions: unlocking a device, launch an application, access to a function, data, and a resource. The conversion of the sequence of indexes of index regions may comprise converting the sequence of input indexes into a plurality of controls comprising changes of values of multiple parameters with a first direction determining a parameter and a signed value of a spin determining a value of change.

The parameter may comprise at least one of: continuous values, discrete values, list values, control parameters, coordinate, distance, position, angle, orientation, frequency, volume, bass, treble, fade, balance, play speed, listening speed, temperature, humidity, time, pressure, acceleration, weight, and position in a list. The method may further comprise providing visual guidance and input feedback during and after the continuous directional input.

The method may further comprise providing a user interface presenting a plurality of index regions in a directional space, and input values associated with index regions. The method may further comprise predicting of the at least one input values based upon previous input values and input statistics.

Another aspect is directed to a system for continuous directional input. The system may include a processor and a memory to track a plurality of parameters of a continuous spatial trace of a parametric process, detect a plurality of positions along the continuous spatial trace that correspond to a plurality of selectable directional input events and subdivide the continuous spatial trace into a plurality of trace segments, calculate directional characteristics in positions of the plurality of selectable directional input events at the ends of each trace segment, determinate input indexes corresponding to the directional characteristics of each trace segment, and convert a sequence of indexes into a plurality of assigned input values.

Yet another aspect is directed to an apparatus with a non-transitory computer-readable medium. The non-transitory computer-readable medium may have computer-executable instructions for causing the apparatus for continuous directional input to perform tracking a plurality of parameters of a continuous spatial trace of a parametric process, detecting a plurality of positions along the continuous spatial trace that correspond to the plurality of selectable directional input events and subdivide the continuous spatial trace into a plurality of trace segments, calculating of directional characteristics in positions of directional input events at the ends of each trace segment, determining of input indexes corresponding to directional characteristics of each trace segment, and converting of a sequence of indexes into a plurality of assigned input values.

### BRIEF DESCRIPTION OF THE DRAWINGS

FIG. 1 is a schematic diagram of an input system, according to the present disclosure.

FIGS. 2A and 2B are diagrams illustrating methods of detection of input events, according to the present disclosure.

FIG. 3 is a schematic diagram of the top level of the user interface for input of continuous directional gestures for English words, represented by a suggestion tree, according to the present disclosure.

FIG. 4 is a schematic diagram of all levels of the user interface for input of continuous directional gestures for English letters, represented by a suggestion tree, according to the present disclosure.

FIG. 5 is a schematic diagram of unambiguous continuous directional traces for English letters, represented by 8 directions indexes at the start and end positions of trace segments between input events, according to the present disclosure.

FIG. 6 is a schematic diagram of the user interface for ambiguous input of continuous directional gestures for English letters, with index regions' sizes being proportional to letter frequencies, according to the present disclosure.

FIG. 7 is a schematic diagram of 3-dimensional continuous directional gestures represented by 6-direction indexes at the start and end positions of trace segments between input events, according to the present disclosure.

FIG. 8 is a schematic diagram illustrating a procedure for device unlocking using on-screen directional gestures, according to the present disclosure.

FIG. 9 is a drawing illustrating a set of strokes for input of English letters based on phone keypad layout and represented by 4 directions indexes and a spin at ends of trace segments between input events, according to the present disclosure.

FIG. 10 is a schematic diagram of the user interface for unambiguous input of digits, represented by 4 directions indexes at ends of trace segments between input events with visual guidance, according to the present disclosure.

FIG. 11 is a drawing illustrating a set of strokes for input of English letters based on letter shape similarity and represented by 4 directions indexes and a spin at ends of trace segments between input events, according to the present disclosure.

FIG. 12 is a drawing illustrating an input interface for control of multiple parameters using 4 directions index of initial direction and a spin, according to the present disclosure.

FIG. 13 is a schematic diagram illustrating the 4-directional spin embodiment of the present disclosure using circular pattern guidance.

FIG. 14 is a schematic diagram illustrating the projection embodiment of the present disclosure based on image and video processing.

### DETAILED DESCRIPTION

The present disclosure will now be described more fully hereinafter with reference to the accompanying drawings, in which several embodiments are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and prime notation is used to indicate similar elements in alternative embodiments.

Generally speaking, the proposed method is based on processing of directional information of a parametric trace, which is determined locally along a trace and doesn't depend on any global characteristics of the trace, like time parameterization, shape or position of a trace. This is done by analysis of the field of the unit tangential direction vector in the vicinity of points of direction singularities. Directional information of trace segments between points of singularities may be indexed and converted into different input values.

The proposed method provides processing of discrete traces, which are traces of different parametric processes, for example: a trace of finger over touch screen, hand gestures, a device orientation tilting curve, path of an object during video tracking. The method reconstructs tangential directions in vertexes of a discrete trace and detects positions of input events, corresponding to singularities of tangential directions. Further, the method determines indexes of trace segments between positions of input events and converts index sequences into input values.

The method may use different algorithms for detection of positions of input events and tangential directions in positions. For example, different range filters may be used at this stage. The discrete vertex mapping of a trace into the directional space determines an image of a trace and its directional characteristics. For example, in the case of 2-dimensional parameterizations, vectors in initial and final points of a trace segment and the spin between them fully determine the directional image of a trace segment. In higher dimensional spaces the method may use other directional characteristics of directional trace. In some embodiments spatial traces may be projected into spaces of smaller dimensions. For example, 3D traces of input object may be projected onto 2D planar traces using video sensors and processing.

The method determines indexes of directional characteristics of trace segments. In an embodiment of the method, the space of values of directional characteristic is subdivided into non-intersecting indexed regions. Indexes of a given trace segment may be equal to indexes of regions of directional characteristics of the segment. For example, in 2D case values of angle of tangential vectors may be subdivided into 4 indexed sectors of 90 degrees, or into 8 indexed sectors of 45 degrees. Sizes of index regions may be equal or different. Region subdivision may be static or dynamic.

The method of the present disclosure then converts sequence of indexes of trace segments into input values or controls. Input values may have any nature, and include, but are not limited to indexes of tree nodes, letters of an alphabet, numbers, syllables, ideographic characters, script elements, words, passwords, stems, strings, macros, control actions, operations, modes, states, functions, symbols, and any object from a list of indexed objects. The method may allow assignment of new values to index sequences, removal and editing of values.

The system of the present disclosure may convert the sequence of indexes into controls, when some indexes determine a parameter, and others determine a value of the change of this parameter. Parameters may have any nature, and include, but not limited to frequency, volume, bass, treble, fade, balance, play speed, listening speed, temperature, humidity, time, pressure, acceleration, weight, coordinate, distance, angle, position in a list, and any other scalar numerical parameters.

The system of the present disclosure may provide a visual guidance and feedback for input. It may display a pattern curves with marked input values to guide a user. The system may display lists of potential candidate input values and use different method of predictions, based on previous input values and input statistics.

The system of the present disclosure may be configured as a part of a mobile or stationary device selected from, but not limited to a group consisting of a radio, a satellite radio, an MP3 player, a personal media device, a GPS device, a medical device, a computer mouse, a refrigerator, oven, climate control device, a portable computer, electronic dictionaries, a phone, a pager, a watch, TV set, dishwasher, washing machine, dryer, thermostat, alarm system, control panel, audio mixer, automobile control panel, dashboard and driving wheel, music mixer, security system, smartcard, remote control device, industrial process control panel and portable input device.

The disclosed input method is based on an approach to processing of inner directional characteristics of traces of parametric processes, which don't depend on shape, position and time characteristics of the traces.

Referring now to FIG. 1, an input system 20 according to the present disclosure is now described. The system 20 is based on continuous directional input. The system may include a processor 23 and a memory 24 to track a plurality of parameters of a continuous spatial trace of a parametric process, detect a plurality of positions along the continuous spatial trace that correspond to a plurality of selectable directional input events and subdivide the continuous spatial trace into a plurality of trace segments, calculate directional characteristics in positions of the plurality of selectable directional input events at the ends of each trace segment, determinate input indexes corresponding to the directional characteristics of each trace segment, and convert a sequence of indexes into a plurality of assigned input values.

### Traces of Parametric Processes

Any parametric process may be represented by a temporal trace of this process in the space of its parameters. This trace comprises a curve in a parametric space and represents how the parameters of the process were changed during the time. For example, in an embodiment of the present disclosure, the parametric process may be a spatial motion of an input object in a coordinate space, which determined by coordinates and orientation of the object, and the trace of the process is an oriented path of an object in a space. For example, in two-dimensional space the process of spatial motion of an input object is determined by 3 parameters: two coordinates of position and an orientation of an input object. The disclosed method analyzes different directional characteristics of segments of traces of parametric processes between some singular points.

Any point at a smooth trace can be mapped into a point in the directional space, which represents directional characteristics of the trace in this point, for example, a unit tangential direction vector to the trace in this point. For example, the directional space may be the unit circle in the case of 2D traces or the unit sphere for 3D traces. Further in the text we will use the term “direction” for “unit tangential direction”.

This directional mapping is similar to Gaussian mapping of the unit normal vector to a curve in a point. The field of direction vectors is determined locally, and depends only on mutual interpositions of points along the curve in some vicinity of a point at a curve. User can easily control the direction vector locally and blindly.

There exist a very close relation between a curve and its directional mapping. It is well known fact of differential geometry, that a unit-speed curve is determined up to a rigid motion of space once we know its direction vector at each point of the curve. So knowing direction vectors, we could accurately reconstruct the whole original curve. The result of the directional mapping of a smooth curve is a smooth directional curve in the directional space. The disclosed method analyzes directional information along a parametric trace to determine positions of input events, in which the directional mapping has some singularities, and to make input recognition, based on directional characteristics of trace segments between positions of input events.

The field of direction vector is smooth in most points along the trace, but may have some positions of singularities, corresponding to singularities of the direction vector along the continuous trace. At first, these positions are start and finish positions of a trace. Another type of singular points is break points; in which the trace is not smooth and the directional trace has discontinuities. The method also may track points of unsigned curvature maxima, which corresponds to points of local maximal turns of the direction vector along the trace. The method also may track zeros of curvature or changes of curvature sign, which corresponds to points of inflexions-changes in the rotation of the direction vector. All these points of singularity are easily controllable by a user drawing a trace. At any moment user can easily make one of these singularities or to avoid them. Analysis of segments of a directional trace between positions of singularities gives us the necessary tool for directional input.

Therefore, the method of the present disclosure is based on analysis of characteristics of segments of directional traces between points of singularities of the directional mapping. In 2D each such trace segments may be described by the initial direction and a spin—a signed total turn angle between final and initial directions, which determines the final direction of the trace segment. All these parameters are easily controllable by a user.

In 3D and in higher dimensions, a segment of the directional trace comprises some trace at the unit sphere. It also has initial and final directions. The system may analyze these and other directional characteristics of the directional trace, which don't depend on position or parameterization of the original trace.

Directional characteristics of smooth trace segments between positions of input events determine some index values, based on various directional index assignments, described further. Index sequences along a trace may be processed by the system into input values associated with these index sequences.

### Discrete Traces

In real world, the system of the present disclosure processes discrete traces of parametric processes, which are discrete approximations of ideal mathematical smooth spatial traces and are represented by a sequence of points of simultaneously tracked parameters of some parametric process at same moments of time. In an embodiment, these parameters may represent coordinates of motion and orientation of an input object along some spatial path. The method may process only coordinate or orientation information.

The disclosed method may use any of existing or future technologies or equipment, providing a tracking of parameters of a motion process (spatial coordinates and an orientation) from sensors.

Coordinate sequences may be tracked using touch screens or panels, image processing, pattern recognitions, optical flows recognition, color recognition, proximity sensors, capacity sensors, pressure sensors, sound, ultrasound and radio location, etc.

The traces may be any projection of the path of the input object in one space to another, for example, from 3D to 2D, using 2D video processing of 3D motion. In one of the embodiments, the method may use only a part of object coordinates.

The method also may track values of any number of orientation parameters from different non-positional sensors, like accelerometer, gyroscope, joystick, compass, tilt sensor, etc. For example, the system can analyze angles of a tilt sensor or acceleration vectors from accelerometer, imbedded into a mobile phone.

In general, the method tracks simultaneously some number of parameters of any process or processes developing in time. These parameters determine positions in parametric space along a discrete spatial trace, representing these processes. The system may determine a directional discrete path and singular positions along these discrete parametric traces.

The system also may track simultaneously motion parameters of several input objects, considering these parameters jointly. For example, two joysticks or d-pads may provide two sets of orientation information.

In different embodiments an input objects could be any traceable object: a pen, a stylus, a wand, a laser pointer, a light source, a light pen, a phone, a watches, a mobile device, a mouse, a joystick, an accessory, an article of closing, a tool, a ring, a bracelet, a glove, a eyewear, a goggles, a helmet, a toy, a drive wheel, a part of the human body (a finger, a palm, a hand, an eye, an iris, a mouth, a head, a foot), etc.

To analyze directional characteristics of a discrete trace, the method determines direction vectors in each position along the path. It may be the vector of difference between two sequential parameter values at the path, or direct displacement value from velocity or acceleration sensors. The sequence of unit directional vectors along a trace of a process determines a directional trace in the directional space.

To reduce a spatial noise during the tracking, different filtration method may be applied. In an embodiment, small changes of parameters less then some threshold value may be ignored, and only displacements greater then this threshold may be registered. The size of the filter threshold may depend on the size of the input object. For example, it can be small for pen input, and big for thumb input at touch screen. Many other vicinity filters may be applied to reduce spatial noise of raw input coordinates. For example, distance filters, or smoothing filters providing a middle point of two consecutive tracked raw positions.

### Input Events

The next step of the method is determination of positions along the trace in which input events occur. In some embodiments, positions of input events are determined by the trace itself, and input events occur in positions of direction singularities along the discrete directional trace. As in the theoretical case of a smooth trace, the method may recognize start and finish positions of a discrete trace as singular points.

The system may use different definitions of singular points. The simplest one is based on analysis of the turn angle 10 between two consequent direction vectors in a position 11: incoming 12 and outgoing 13 ones, and demonstrated in diagram 30 at FIG. 2A. The absolute value of the turn angle may be used for approximation of the curvature and correspondingly detection of singular points. If the turn angle is greater then some predefined angle threshold, then we may classify the point of a discrete trace as a singular point.

Another embodiment of a method of detection of singular points is based on analysis of behavior of the discrete trace in the vicinity of a test position, and demonstrated in diagram 35 of FIG. 2B. The method may consider a cone of directions 14 of some threshold angle from the test position 11 around the direction coinciding with incoming direction vector 12. Then the method tracks consequent trace positions 15, 16, 17 until they exit some predetermined vicinity 18 of the test position 11. If all these point are within the cone 14, the method considers the test point 11 as a smooth point of the trace. Otherwise, the test position 11 is a singular position. This approach combines both filtering and detection of singularities. It may detect small loops, and sharp deviations from the incoming direction. This may improve a detection of singularities, when incoming and outgoing directions are close. In case of planar traces the turn angle has a sign, so changes of the sign might determine inflection points at the trace, and corresponding singularities.

Another embodiment method of detection of positions of input events may be based on detection of singularities of components of direction vector. In the general case, coordinates of N-dimensional vector may be subdivided into groups, and system may tracks singularities of coordinates within these groups. For example, 2-dimensional coordinates may be considered as two independent 1-dimensional parameters. The only singularities of 1-dimensional parameter are extreme points, determined by changes of sign of direction vectors. The method may consider a point of 2-dimensional trace as a singular, if any of its coordinates has 1-dimensional singularity in this point. In the general case on N-dimensional trace it has a singularity in a position, if any of its coordinate group has a singularity in this position. This approach may be very beneficial for directional input of traces in high dimensions, for example simultaneous tracking of the position and the orientation of the input object. It also beneficial for tracking of parameters from several input objects.

Another embodiment may use one of tracked parameters for detection of input events. The method may recognize extremes of this parameter for detection of input events. For example, 2 coordinates of a point at 3D trace may be used for determination of the direction and the third coordinate for detection of input events. This embodiment is very well suite for the tracking of accelerometer parameters.

The method may also use any coordinate independent approach to trigger input events. In one of the embodiments the method may use touches of a button, a key or a touch sensor at the body of input object for this purpose, for example clicks of a mouse button may be used as input events for directional input using a computer mouse. It also maybe some changes of the state of input object, for example eye blink or palm closing. Triggering of the state determines a time and correspondingly a position of input event.

### Input Indexes

After detection of positions of input events, the method registers an input event and analyzes directional characteristics of the segment of the discrete trace between two consecutive positions of input events. Directional characteristics along the trace segment are mapped onto the directional space. The next step of the method is determination of input indexes corresponding to directional characteristics at the ends of trace segments. This is a beneficial property of the method of present disclosure, that it uses directional information only in position of input events. Directional characteristics in points between positions of input events don't impact to input values. This is very different to any other known positional and directional input methods, which depends on shape of the entire trace. This allows a user to concentrate on trace shape only at moments of input events.

In the embodiment a determination of the input indexes corresponding to the directional characteristics is based on a determination of which index regions from a plurality of index regions in a space of directional characteristics include said given directional characteristics. In one embodiment, the directional space may be subdivided into a plurality of index regions. They could be of any shape and size in the directional space. For example, for planar traces and 1-dimensional directional space, index regions are segments of the unit circle. For 3D traces, they could be regions of any shape at the unit directional sphere. Index regions may be defined statically, or calculated for each input event. Each index region may have an index associated with it. To determine an index corresponding to a plurality of directional characteristics, the method finds a region containing these directional characteristics. In some embodiments, all index regions may have equal sizes, and system may use simple arithmetical operation to determine a region index. For example, the directional space may be subdivided into 4, 6 or 8 equal parts. Indexes of other directional characteristics of trace segments, like spins, may be calculated based on indexes of initial and final directions.

Direction vectors at positions of input events determine index regions in the direction space containing these direction vectors. To compensate the accuracy of the tracking of direction vectors the method may consider some angle neighborhoods around direction vectors. In this case, the method determines what index regions are intersecting with the vicinity of direction vectors. This determination may be unambiguous, if the vicinity of the direction intersects only with one index region. In case of mutual intersection, the selection of the index region is ambiguous and this ambiguity may be resolved at the later stages. Determination of index regions may be ambiguous also in case when index regions are overlapping. For example, the method may extend non-overlapping regions of the above case to the size of vector vicinity and new regions may become overlapping.

In one embodiment, the method of present disclosure utilizes information of direction vectors and a spin between them only in positions of input events. Information on the trace in all other positions between positions of input events is not used for indexing. This provides a user a flexibility of input. The user should control the trace only at moments when he wants to make an input, but not in all positions of the trace. This is one of principal differences and benefits of the disclosed directional input method comparing to known positional input methods, which require input control in all positions of the trace.

In general, the index assignment may be any function of any number of directional characteristics of the trace segment: an initial direction, a final direction, and a spin between them. For example, in one of the embodiments, only the value of the spin—the total turn angle may be used for determination of the index. In this embodiment, the spin index becomes independent on initial and final directions, so correspondingly independent on rotations of the original trace. This embodiment may be beneficial for cases, when determination of absolute values of directions in some coordinate system is difficult, for example for tracking accelerometer values, which depends on orientation of accelerometer itself. Different embodiments of index assignments are described in details in the next section.

### Input Values

After determination of input indexes of the trace segment, the method processes the sequence of indexes to determine input values. Different input values may be assigned to index groups. The assignment of values may be ambiguous, when several input values are assigned to one index. The method may use different input assignments. Inputs values could be letters, characters, symbols, words, lexicographic intervals, stems, part of words, nodes of a tree, positions in menus, actions, functions, operations, commands, decisions, modes, states, etc.

If index or input value assignments are ambiguous the method may resolve it immediately at the next step of input, or delay a disambiguating until the whole path is tracked. After each input event the system has a set of candidate input values. In some of the embodiments, this set may be represented as a hierarchical tree. One input value in this set may be the preferred, default candidate input value, which may be entered after the trace is finished.

In some embodiments, at any moment of the input process, a default input candidate may be displayed for acceptance. Acceptance maybe assigned to the end of the path or some index value. If there are several input candidates, the desired input candidate may be selected via the same directional interface with unambiguous assignment of candidates to index sequences.

The processing of input indexes and values is complete at the moment, when the method determines an unambiguous input value.

After each input event, system may make index and/or input values reassignment based on some procedure. Embodiments with constant index assignment or limited number or different index assignments may be easily memorized by a user and provide blind input. Several embodiments of the method are described in details below.

### 8-Directional Word Input

In this embodiment for word input, all words of some set of words are assigned hierarchically to regions of the direction space, using suggestion trees (U.S. Patent Application Publication No. 2012/0254297 to Kuzmin) accordingly their frequencies and alphabetical order. They determine the input object space. An example of such object space subdivision for English words and 8 index regions is demonstrated in diagram 40 of FIG. 3. It shows the first level of the user interface and an example of input. At the beginning of the gesture, the current node of the tree is its root node. Each input event at the gesture determines unambiguously a region in the direction space and correspondingly the index, using the direction in the end point of each trace segment. This is a static 8-regions embodiment, using only final directional vector. The index determines the index of a son node in the hierarchical tree for the current node, and a list of candidate words represented by a sub-tree of this node. This process may be continued until a terminal node, determining the input unambiguously, is reached.

At each moment, the default input word candidate is the most frequent word in the candidate list, and may be entered by finishing the gesture. To simplify the interface, only the common stems of words belonging to the candidate list and a few other letters determining nodes of the decision tree may be displayed to a user. In the example, demonstrated at FIG. 3, the method displays only one ambiguous letter determining the node of the decision tree. In this case, the gesture, determining a word in the list of 5000 most frequent English words, contains about 2.5 segments. This provides easily memorization of each word's shorthand.

This embodiment also provides the efficient tool for word disambiguation for other embodiments of the method, based on directional input of letters, symbols, strokes, sounds, and any other word parts determining the input of words.

### 8-Directional Letter Input

In another embodiment for input of letters, presented in a diagram 50 of FIG. 4, the directional space is subdivided into several, for example eight, non-intersecting regions. After each input event, the corresponding index region is selected accordingly to the finish direction of the segment of the directional trace. These regions determine 8 indexes. Letters of alphabet may be assigned to nodes of static 8-ary suggestion tree for frequencies of letter usage (U.S. Patent Application Publication No. 2012/0254197 to Kuzmin) and indexes determine the path in this tree. If the node is not terminal, the system disambiguates letter inputs during processing of the next trace segment. 6 most frequent letters may be entered by one segment, 4 by two segments, and 6 less frequent ones by 3 segments of a continuous trace. At each moment the system may also provide a list of candidate words and a default word, determined by already disambiguated letters or intervals of letters. If a desired word is the default word or is in the candidate list the user may finish the trace. In the case of candidate list, user may switch to the embodiments described above for word disambiguation. In most cases the desired word is defined before completing entire trace for a word and number of strokes is close to described above embodiment for word disambiguation.

Such short continuous directional gestures comprising a traversal of suggestion trees representing words might be a very efficient way of shorthand input and writing for any language, especially for non-alphabet languages, like Chinese, already based on graphical representations of words. After some learning period user might input these shorthand gestures fast and blindly.

Continuous directional gestures may be also very beneficial for persons with communication disabilities. For example, person with speech/hearing disabilities may use 8-directional hand gestures for intercommunication. Such directional gesture sign language is easier and faster then many existing systems of sign communications. An apparatus utilizing position and motion sensors may be used for recognition of the sequence of displacement of directional hand gestures in the space and conversion of these sequences into speech. 8-directional stroke signs also may be used for blind persons as body language, using tactile signs, or as a language-independent substitution of letter-based Braille alphabet. Stroke signs also may be used in situations, when other means of communications are limited, for example, as visual and tactile gestures for military communication. Additionally, both methods for input of words and symbols using continuous directional gestures may be combined to provide the possibility of input of non-dictionary words.

Input with Two Directional Indexes

In other embodiments, the system may use both start and finish directions of each trace segment for determination of indexes. For example, in the case of 8 indexes per a direction, the method may have up to 8*8=64 different index combinations, and correspondingly input values. To simplify the interface, the method may use different number of indexes for directions, for example 8 (by 45 degrees) for start and 4 (by 90 degrees) for finish directions. That provides 32 different indexes totally.

In another similar embodiment, the system may use incoming and outgoing directions in each position of input events for determination of index. In this case, these directions are different, so the method again may recognize up to 8*8=64 different inputs for 8 directional regions. To handle situation when the finish direction of one trace segment is close to the start direction of the next trace segment user may make small loops or step backs at the end of the first segment. The FIG. 5 shows a diagram 60 demonstrating the tree of segment shorthands for unambiguous letter input and a sample of input for this embodiment. To enter a letter, which corresponds to a segment of a gesture, a user draws a shorthand directionally equivalent to a path from the center of the tree to the corresponding letter. This embodiment may be also based on Braille coding for blind input, with the first index representing left column and the second code representing the right column of a Braille symbol.

Another embodiment using both direction indexes may have 4 indexes per direction. In this case method may have 16=4*4 input values. This embodiment may be used for implementation of numeric input and as a substitution of numeric keypad. FIG. 9 shows a diagram 100 that demonstrates an example of input traces for this embodiment. Only 12 traces are drawn, all are starting at the center of the square. Embodiments with small number of indexes, like 4, provide additional simplicity of input and more accurate input recognition. Since many devices have rectangular displays and/or input sensors, a user has additional visual guidance of principal directions based on directions of sides of a device.

In all embodiments of the present disclosure a visual help may be displayed to user to facilitate selection of directions and input values. FIG. 9 demonstrates a small, square input field with numeric symbols along sides of the input field providing a visual help for described above 4-index input embodiment. A visual help maybe implemented as a permanent symbols or as dynamic symbols at a screen. After some learning and memorization period a user is able to enter numbers and letters blindly without visual help.

### Index Regions of Different Sizes

In another embodiment, shown in diagram 70 of FIG. 6, index regions may have different sizes. In this example, indexes and correspondingly letters of an alphabet are assigned to non-intersecting index regions of the direction space. The size of regions may be proportional to the usage frequency of assigned letters. After each input event, index regions overlapping with vicinity of the final direction in the end of the trace segment are determined. Letters assigned to selected index regions determine letters at the corresponding position in a candidate words. Additional weights may be assigned to letters accordingly to angle difference between final direction of a trace segment and letter direction. The most frequent word with these weighted letters in the positions may be presented as a default candidate.

Differently to letter input embodiment at FIG. 4, this embodiments may not resolve an ambiguity of individual letters until the end of a gesture, because the vicinity of input vector may overlap several index regions. If the default candidate is not a desired word, then after the end of a gesture the list of all candidate words may be presented to user for selection of desired word, using word disambiguation method described above. In a diagram 80 of FIG. 7, the system recognizes the word “the”.

### Spin Embodiments

A number of embodiments of the present disclosure also may use a signed value of the spin of a trace segment between positions of input events for determination of input indexes. Initial and final directions of the trace segment may be indexed to any number of intervals in the direction space as described above. An indexed value of the spin represents the signed angle value of rotation of the tangent vector along the trace segment between initial and final directions. Any of directional embodiments described above may also use spin information to extend a set of possible inputs.

In the embodiment of 4-directional indexing, directions and a spin value of a trace segment may be subdivided into equal intervals of 90 degrees. An indexed direction may have 4 indexes, corresponding to 90 degrees sectors and directions: 0—UP, 1—RIGHT, 2—DOWN, and 3—LEFT. A spin index may be determined by the subdivision of a signed value of a spin between these two indexed directions to 90 degrees. For example, in a diagram 110 of FIG. 10, the index of the initial direction of the trace segment representing the letter “Y” is UP, the index of the final direction is LEFT, the value of spin between these directions is +270 degrees, so its spin index is +3. At the same time, the spin index of the trace segment representing the letter “T”, which has the same indexes of initial and final directions, is −1. This embodiment of 4-directional indexing with spin is very beneficial for many applications, because it utilizes a reduced number of only four principal directions, providing more simple input shapes from one side, and unlimited number of spin values, providing a flexibility of input from other side.

One of the embodiments of 4-directional spin indexing may be character input. An index of one of four initial directions and a spin index of a stroke may determine an input symbol.

In one of the embodiments, demonstrated at FIG. 10, at first, all letters may be subdivided into 4 groups, based on an index of the initial direction. These groups may be further subdivided into two subgroups, based on a sign of spin index, and then the value of spin index may determine a letter in the group. To simplify memorization and use, this subdivision may mimic the standard 8-keys letter grouping of the phone keyboards: ABC, DEF, GHI, JKL, MNO, PQRS, TUV, WXYZ. For example, indexes of letter “L” may be: down direction, positive sign, third in the group. This embodiment also provides input of control symbols, like DEL, SPACE, etc. In another embodiments indexing may be based on letter frequencies, providing shorter strokes for more frequent letters. Yet in another embodiments indexing may be based on indexes of Braille letters.

The shape of trace representing a symbol may also partially resemble the shape of handwritten symbols. FIG. 11 includes a diagram 120 that demonstrates one of the embodiments of 4-directional spin input, based on visual similarity of symbol shapes for English alphabet. Each letter is determined only by one of four initial directions and a signed index of a spin angle. In another embodiment, letter shapes may comprise several trace segments and be determined by the sequence of indexes of these segments. Users may easily re-define and reassign meanings of shapes depending on their preferences. Symbols may be written continuously. Different control symbols may be added as in the previous embodiment.

These embodiments resemble Graffiti approach, but are based on principally different recognition method. Graffiti is shape recognition method and analyses shape, length and interposition of strokes in all points of strokes, but the disclosed method processes just directional information only in end points of trace segments. For example, shapes of cursive letters “h” and “n” are different for shape recognition methods, but are the same for the method of the present disclosure, because it uses only directional information at the ends of a trace segment and doesn't process information on length and shape of strokes between positions of input events. Another examples may be recognition “d” and “q”, “s” and “-”. Also differently to the method of U.S. Pat. No. 7,519,748 to Kuzmin, the described method doesn't depend on position information and provides position-independent recognition of input. The method of the present disclosure is also continuous and doesn't require separation of symbols for recognition.

Described above 4-directional spin embodiments provide an input interface, which may be beneficial for small electronic devices with limited input area, like phones and watches. Symbol shapes may be easily memorized, adjusted, and re-assigned. 4-directional spin input is very well suited for blind input due a small amount of principal directions, which are parallel to the sides of a device or a screen. The input method may be implemented using touch screens, 4-directional d-pads, joysticks, mouse, and many other tracking input devices. An unlimited number of indexes may be beneficial for text input for languages with a large number of glyphs, like Indian or Thai. Symbols may have several strokes and be written continuously without interruptions between symbols. For example, input of capital letters maybe done by stroking a short flick in the direction opposite the final direction of symbol.

### Input of Multiple Parameters

The method of the present disclosure may also be very beneficial for simultaneous control of multiple parameters for broad range of consumer, industrial, military, scientific equipment and devices. The initial direction of a trace segment may determine selection of one of several controllable parameters, and the signed value of the spin of a trace segment may determine the signed value of a change of the selected parameter.

For example, in the embodiment for radio control, the initial direction UP may determine VOLUME control with clockwise spinning determining the value of volume increase, and counter-clockwise spinning determining the value of volume decrease. The initial direction DOWN, may determine frequency control with similar meanings of spinning. Any other parameters including, but not limited by volume, frequency, bass, treble, fade, balance, play speed, listening speed, temperature, humidity, time, date, pressure, acceleration, weight, coordinate, distance, direction, angle and position in a list may be simultaneously controlled using this approach.

For example, in one embodiment, shown in diagram 130 of FIG. 12, a user may control a watch selecting initial directions: UP for input of hours, RIGHT for minutes, DOWN for alarm hours, and LEFT for alarm minutes, following by spinning in either of two orientations determining the value of change of corresponding parameters. In another embodiment values of time and temperature may be entered in this way for ovens. In climate control unit, a temperature and humidity may be also entered in the same way. In media player the input method of the present disclosure may control a volume, a track, a channel, and a position within a composition or a movie.

The list of such devices which may benefit of the method of the present disclosure includes, but not limited by a radio, a satellite radio, an MP3 player, a personal media device, a GPS device, a medical device, a computer mouse, a refrigerator, oven, climate control device, a portable computer, electronic dictionaries, a phone, a pager, a watch, TV set, dishwasher, washing machine, dryer, thermostat, alarm system, control panel, audio mixer, automobile control panel, dashboard and driving wheel, music mixer, security system, smartcard, remote control device, industrial process control panel and portable input device.

Such directional, blind input may be beneficial during the driving using a touch pad at driving wheel or at a console.

### Pattern Input

An embodiment of the present disclosure may use guiding planar curves as patterns for directional input. A user may trace his finger along some predefined pattern convex curve, for example a circle, starting from some position at the circle. To enter an input event in a desired position along a pattern curve, a user may change the direction of tracing to the opposite one or lift the finger. For example, a user may change the orientation of rotation along the circle. Since the position at a smooth curve uniquely determines a tangential direction to this curve in this position, the method may use it for determination of an input index. The sequence of directional indexes in positions of changes of tracing direction along a curve may be processed further using any index and input value assignments described above for planar directional traces. Such pattern curve patterns embodiment may be beneficial, because a position along a curve is determined by only one parameter, but tangential vector provides two coordinates, which are necessary for the method. This embodiment may use circular dials or wheels for directional input.

FIG. 13 includes a diagram 140 that demonstrates a circular pattern for directional input with 4 directions. To enter a symbol user starts a gesture in the position of a group containing a letter, and make spin with index equal to a position of a letter in the group. For example, to enter letter “B” user starts a gesture in position 101 moving up, and makes a counter-clockwise spin to position 102. In this case the initial direction is UP and the spin is 2. The same circular pattern embodiment may be used for parameter control. Initial positions along a pattern curve determine initial directions and parameters, and spins around circles determine a change of a value of parameters.

Pattern curves also may be used for the guided directional input to provide a visual help for a user. After each input events the method may draw a pattern curve and mark points along it, corresponding to input events. This may be beneficial for user during the study of the method. Other types of visual guidance and user interfaces may be used by the method to simplify the process of the directional input. For example, pie diagrams showing potential input values for different directions may be very beneficial.

### Input Prediction

The method of the present disclosure may use any existing methods of input prediction for input acceleration. As it was mentioned above, the method may set index regions of different size depending of expected probabilities of different input values. In another embodiment the method may display a list of candidates for selection, based on previous input values and statistics. For example, after input of a part of a word the method may predict following letters or parts of a word. It also may predict words, based on previously entered words.

The method of the present disclosure may use directional input for the selection of predicted input candidate in a list. For example, the list of candidates may be presented as a directional pie diagram, and the user may select a sector of a diagram containing a desired candidate.

### 3D Input

Many embodiments of the present disclosure may be based on tracking of 3-dimensional motions using motion detectors, accelerometers, tilt sensors and a compass, providing information on position and orientation of the input object. In general case 3d trace provides much more directional information then 2d traces. The system of the present disclosure may use any subset of this information.

An embodiment of the method may process directional information of planar projections of 3D traces using any of 2D embodiments described above. For example the method may use two planar projections of 3D trace for processing.

The method also may use true 3D processing. In one embodiment of index determination, the method may use a subdivision of the unit directional sphere onto 6 equal index regions, corresponding to the principal coordinate directions. To make an input, the user makes spatial directional gesture. To simplify user interface, the directional gesture may comprises directional trace segments between adjacent principal directions. In this way we may determine 6×4=24 different indexes for trace segments as illustrated at FIG. 7. Twelve traces marked at the FIG. 12 may be passed in both directions. That provides the system with 24 different spatial gestures.

Another 3D embodiment may utilize per-coordinate detection of singularities. This embodiment utilizes three 1-dimensional projections of a spatial trace onto coordinate axes. It may detect positions along a trace in which all three coordinates of direction vectors change their signs. This embodiment provides 8 indexes per trace segment, corresponding to vertexes of a cube.

### Object Orientation Traces

In another embodiment, the system may track orientation parameters for the processing of directional gestures. For example, values of tilt sensor or joystick represent a 2-coordinate vector of deviation of orientation of the input object from some base axis. They determine gestures in 2-dimensional polar parameterization. The method of the present disclosure may determine corresponding directional gestures and singular points of orientation trace. After that it may use them for index calculation. For example, in one embodiment, the system may use orientation direction vectors in the final points of input trace segments for index determination and use directional input assignments as described above for embodiments with one directional vector. Such tilt input may be beneficial for blind and hands free input.

### Video Processing

A number of embodiments of the present disclosure are based on image and video processing. There are two principal cases of the processing.

In one embodiment, demonstrated at FIG. 14, a static camera 151 may track a trace of a spatial motion 152 of some input object 153, for example, a finger, a hand, a head, an eye iris of the user or any other input object and process coordinates of its projection at the camera matrix determining a discrete curve 154 in 2D parameterization of camera matrix. The trace of input object may be visualized for a user to simplify input. The projected 2D trace may be further processed using any of the planar embodiments described above for determination of position of input events, indexing of directional characteristics and input value assignments. The camera 151 may be embedded into a computer, TV, phone, glasses, or any other equipment providing control of this equipment.

Another embodiment of video tracking utilizes a camera imbedded into the input object, similarly to optical computer mouse. Using methods of image and video processing the camera may track up to 5 parameters of the spatial motion of the input object: 3 coordinates and 2 angles of orientation of the input object. In some embodiment the system may use only a part of these parameters, for example a camera imbedded in to a pen or mouse may use only two coordinate parameters in relation to the input surface. In another embodiment a camera embedded into glasses may track only parameters of head orientation. A camera embedded into smart watches may track motions and an orientation of a hand. Due small sizes of camera, image-processing embodiments may be very beneficial for control smart watches, glasses, pens and other small mobile and wearable devices. The pen-based camera may be used for character input as described above.

### Device Access and Function Control

In another embodiment, a directional traces may be used for switching a device 90 between different modes and applications, as illustrated at FIG. 8. For example, it may be used as a directional gesture password 91 to unlock a device 90, to switch from a locked state to a phone state, or to lunch some application. To unlock the device 90 or to change a device state, the user assigns an operation, for example “unlock”, to index sequence of some user-defined directional gesture 71. During the recognition stage, the sequence of indexes (“6248” in our example) for the entered directional gesture 91 is compared to the stored exemplary index sequences for pre-assigned gestures 71, and if they are the same (“6248”), then the device is unlocked. Any of embodiments of detection of input events and determination of indexes described above in the application may be used for device control. FIG. 8 demonstrates the procedure of device unlock using on-screen 8-directional gestures. In other control embodiments, 3-dimensional spatial directional gestures and tilts may be used for unlock and mode switching. Such directional gestures may increase the security of devices and prevent non-authorized access to device, information, functions and applications.

Directional gestures may be used as passwords for access to different restricted functions, data, files, applications, and other system resources. The directional gestures are also more secure comparing to positional, because doesn't depend on position and shape of a gesture at the screen, which may be recovered based on finger traces.

One of ordinary skill in the art will recognize that the present embodiments may be incorporated into hardware and software systems and devices for input. These devices or systems generally may include a computer system including one or more processors that are capable of operating under software control to provide the input method of the present disclosure.

Computer program instructions may be loaded onto a computer or other programmable apparatus to produce a machine, such that the instructions, which execute on the computer or other programmable apparatus together with associated hardware create means for implementing the functions of the present disclosure. These computer program instructions may also be stored in a computer-readable memory that can direct a computer or other programmable apparatus to function in a particular manner, such that the instructions stored in the computer-readable memory together with associated hardware produce an article of manufacture including instruction means which implement the functions of the present disclosure. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions of the present disclosure. It will also be understood that functions of the present disclosure can be implemented by special purpose hardware-based computer systems, which perform the specified functions or steps, or combinations of special purpose hardware and computer instructions.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

That which is claimed is:

1. A method for continuous directional input comprising:
using a processor and memory to
track a plurality of parameters of a continuous spatial trace of a parametric process,
detect a plurality of positions along the continuous spatial trace that correspond to a plurality of selectable directional input events and subdivide the continuous spatial trace into a plurality of trace segments,
calculate directional characteristics in positions of said plurality of selectable directional input events at ends of each trace segment,
determine input indexes corresponding to the directional characteristics of each trace segment, and
convert a sequence of indexes into a plurality of assigned input values.

2. The method of claim 1 wherein the parametric process comprises a motion of an input object; and wherein the continuous spatial trace is defined by a temporal sequence of any subset of a plurality of values of positions, directions and orientations of the input object during the motion.

3. The method of claim 2 wherein the continuous spatial trace comprises a path of touch position of the input object in a coordinate space of a touch sensor.

4. The method of claim 2 wherein the continuous spatial trace comprises a path of an image of the input object in projection to an image space of a video camera.

5. The method of claim 2 wherein the continuous spatial trace comprises a path of the input object reconstructed by a processing a video from a camera embedded in the input object.

6. The method of claim 2 wherein the continuous spatial trace comprises a path having a shape based upon a handwritten symbol.

7. The method of claim 2 wherein the input object comprises at least one of: a sensor, a camera, a stylus, a pen, a wand, a laser pointer, a cursor, a ring, a bracelet, a glass, an accessory, a tool, a phone, a watch, an input device, a toy, an article of clothing, a finger, a hand, a thumb, an eye, an iris, a part of human body, a joystick, and a computer mouse.

8. The method of claim 1 wherein the positions of the plurality of selectable directional input events along the continuous spatial trace comprise at least one of: initial and final positions, positions of direction changes, positions of direction discontinuous, positions of direction extremes, positions of extreme values of curvature, positions of stops, positions of inflexion, positions of orientation changes, and positions of orientation extremes.

9. The method of claim 1 wherein the positions of the plurality of selectable directional input events comprise positions of user triggered events.

10. The method of claim 1 wherein the directional characteristics for each trace segment comprise at least one of the following: directions of tangential vectors to a trace and orientation vectors of an input object at positions of input events at ends of the trace segment and signed spins between these vectors along the trace segment.

11. The method of claim 1 wherein the determination of the input indexes corresponding to the directional characteristics is based on a determination of which index regions from a plurality of index regions in a space of directional characteristics include said given directional characteristics.

12. The method of claim 11 wherein each index region from the plurality of index regions has an equal size.

13. The method of claim 11 wherein each index region from the plurality of index regions has a size proportional to a respective frequency of an assigned input value.

14. The method of claim 11 wherein at least two index regions from the plurality of index regions are overlapping.

15. The method of claim 1 wherein the input values comprises at least one of: nodes of a tree, letters of an alphabet, symbols, numbers, syllables, ideographic characters, script elements, words, passwords, stems, strings, macros, control actions, tasks, operations, states, functions, applications, decisions, outcomes and any other values from a list of indexed values.

16. The method of claim 1 wherein the conversion of the sequence of indexes of index regions further comprises editing of input values assigned to input indexes, assignment of new input values, and deletion of assigned input values.

17. The method of claim 1 wherein the conversion of a sequence of indexes of index regions further comprising a disambiguation of indexes and selection of desired input values from a set of input values associated with overlapped index regions.

18. The method of claim 1 wherein the conversion of the sequence of indexes of index regions comprises comparing the sequence of input indexes to pre-defined password sequences of indexes to perform at least one of actions: unlocking a device, launch an application, access to a function, data, and a resource.

19. The method of claim 1 wherein the conversion of the sequence of indexes of index regions comprises converting the sequence of input indexes into a plurality of controls comprising changes of values of multiple parameters with a first direction determining a parameter and a signed value of a spin determining a value of change.

20. The method of claim 19 wherein the parameter comprises at least one of: continuous values, discrete values, list values, control parameters, coordinate, distance, position, angle, orientation, frequency, volume, bass, treble, fade, balance, play speed, listening speed, temperature, humidity, time, pressure, acceleration, weight, and position in a list.

21. The method of claim 1 further comprising providing visual guidance and input feedback during and after the continuous directional input.

22. The method of claim 1 further comprising providing a user interface presenting a plurality of index regions in a directional space, and input values associated with index regions.

23. The method of claim 1 further comprising predicting of the at least one input values based upon previous input values and input statistics.

24. A system for continuous directional input comprising:
a processor and a memory to
track a plurality of parameters of a continuous spatial trace of a parametric process,
detect a plurality of positions along the continuous spatial trace that correspond to a plurality of selectable directional input events and subdivide the continuous spatial trace into a plurality of trace segments,
calculate directional characteristics in positions of the plurality of selectable directional input events at the ends of each trace segment,
determinate input indexes corresponding to the directional characteristics of each trace segment, and
convert a sequence of indexes into a plurality of assigned input values.

25. The system of claim 24 wherein the parametric process comprises a motion of an input object; and wherein the continuous spatial trace is defined by a temporal sequence of any subset of a plurality of values of positions, directions and orientations of the input object during the motion.

26. The system of claim 24 wherein the positions of the plurality of selectable directional input events along the continuous spatial trace comprise at least one of: initial and final positions, positions of sharp direction changes, positions of direction discontinuous, positions of direction extremes, positions of extreme values of curvature, positions of stops, positions of inflexion, positions of orientation changes, and positions of orientation extremes.

27. The system of claim 24 wherein the directional characteristics for each trace segment comprise at least one of the following: directions of tangential vectors to a trace and orientation vectors of an input object at positions of input events at ends of the trace segment and signed spins between these vectors along the trace segment.

28. The system of claim 24 wherein the determination of the input indexes corresponding to the directional characteristics is based on a determination of which index regions from a plurality of index regions in a space of directional characteristics include said given directional characteristics.

29. The system of claim 24 wherein the conversion of the sequence of indexes of index regions further comprises editing of input values assigned to input indexes, assignment of new input values, and deletion of assigned input values.

30. An apparatus with a non-transitory computer-readable medium, wherein the non-transitory computer-readable medium having computer-executable instructions for causing the apparatus for continuous directional input to perform:
tracking a plurality of parameters of a continuous spatial trace of a parametric process;
detecting a plurality of positions along the continuous spatial trace that correspond to the plurality of selectable directional input events and subdivide the continuous spatial trace into a plurality of trace segments;
calculating of directional characteristics in positions of directional input events at the ends of each trace segment;
determining of input indexes corresponding to directional characteristics of each trace segment; and
converting of a sequence of indexes into a plurality of assigned input values.

31. The apparatus of claim 30 wherein the parametric process comprises a motion of an input object; and wherein the continuous spatial trace is defined by a temporal sequence of any subset of a plurality of values of positions, directions and orientations of the input object during the motion.

32. The apparatus of claim 30 wherein the positions of the plurality of selectable directional input events along the continuous spatial trace comprise at least one of: initial and final positions, positions of sharp direction changes, positions of direction discontinuous, positions of direction extremes, positions of extreme values of curvature, positions of stops, positions of inflexion, positions of orientation changes, and positions of orientation extremes.

33. The apparatus of claim 30 wherein the directional characteristics for each trace segment comprise at least one of the following: directions of tangential vectors to a trace and orientation vectors of an input object at positions of input events at ends of the trace segment and signed spins between these vectors along the trace segment.

34. The apparatus of claim 30 wherein the determination of the input indexes corresponding to the directional characteristics is based on a determination of which index regions from a plurality of index regions in a space of directional characteristics include said given directional characteristics.

35. The apparatus of claim 30 wherein the conversion of the sequence of indexes of index regions further comprises editing of input values assigned to input indexes, assignment of new input values, and deletion of assigned input values.
